(19) United States
(12) Patent Application Publication
(10) Pub. No.: US 2017/0310751 A1
(43) Pub. Date: Oct. 26, 2017

(54) SYSTEM AND METHOD FOR CLOUD STORAGE DEVICE DETECTION

(71) Applicants: Kabushiki Kaisha Toshiba, Minato-ku (JP); Toshiba TEC Kabushiki Kaisha, Shinagawa-ku (JP)

(72) Inventors: Michael L. Yeung, Mission Viejo, CA (US); Jia Chen, Monterey Park, CA (US)

(21) Appl. No.: 15/133,752

(22) Filed: Apr. 20, 2016

(51) Int. Cl. H04L 29/08; H04L 12/24

(52) U.S. Cl. CPC H04L 67/1097; H04L 41/22

(57) ABSTRACT

A document processing system includes an embedded controller that has both a local area network interface for receiving documents over an associated network and a wireless personal area network interface for communicating with mobile computing devices using BLUETOOTH low power communications. The embedded controller transmits broadcasts message to nearby mobile computing devices that send responses to the broadcast messages. Based on the RSSI of a received response, the embedded controller can determines whether a particular mobile computing device is in close proximity, indicating that a user is present at the document processing system. The embedded controller sends identification data associated with the document processing system to the mobile computing device. The user of the mobile computing device selects the document processing system to print a document, and the mobile computing device uses the identification data to route the document to the document processing system over a wireless local area network.

### TECHNICAL FIELD

The subject application teaches embodiments that relate generally to discovering cloud storage services, and specifically to a mobile computing device that populates a cloud storage service selection list based on associated cloud storage service applications installed on a user's mobile computing device.

### SUMMARY

In an example embodiment, a method includes retrieving identifying data about cloud storage applications resident, or installed, on a mobile computing device, generating a list of cloud storage devices based on the identifying data, and presenting at least a portion of the list, for example by displaying the list to a user on a display of the mobile computing device, accepting a selection of one of the cloud storage devices from the list as the selected cloud storage device, and outputting data to the selected cloud storage device, for example by printing from the mobile computing device to the selected cloud storage device. The operation of retrieving identifying data can include querying the operating system of the mobile computing device for identifying data. In various configurations, the operating system can be an iOS operating system, an Android operating system, a Linux-based operating system, or a Microsoft Windows operation system. Each cloud storage device in the generated list of cloud storage devices can be approved against a company policy, for example to ensure each cloud storage device is on an approved list of cloud storage devices or to ensure a suitable level of encryption is used during communications with the cloud storage service. The method can further include removing from the list one or more cloud storage devices that are not associated with a cloud storage application that is currently resident on the mobile computing device. The method can also include modifying the list to include a cloud storage device that is associated with a resident cloud storage application that has been installed on the mobile computing device, for example a cloud storage application that has been installed since the last time the operating system was queried. The method can also include refreshing the list of cloud storage devices, for example based on a user request to refresh the list, the opening or execution of an application, the reactivation of an application, for example an application that was out of scope for a period of time and then brought back in scope, and a periodic timer. The operation of presenting can include passing some or the entire list to a separate application that is also executing on the mobile computing device. The operation of accepting a selection of a cloud storage device can include accepting a user selection via an input associated with the mobile computing device. The operation of outputting data can include transmitting data to the selected cloud storage device via a wireless network interface of the mobile computing device.

In an example embodiment, a mobile computing device includes a memory that is operable for the storage of data and instructions, a network interface that is configured for mobile or wireless communications, a display configured to visually present data to a user, an input configured to accept user inputs from a user, and a processor in data communication with the other components of the mobile computing device. The processor is configured to retrieve identifying data about cloud storage applications that are resident on the mobile computing device, for example by retrieving the identifying data from memory or by querying the operating system. The processor generates a list of cloud storage devices based on the retrieved identifying data and presents all or a portion of the list on the display to the user. The processor accepts a user selection of one of the cloud storage devices from the list as the selected cloud storage device via the input of the mobile computing device. The processor outputs data to the selected cloud storage device via the network interface. In a configuration, the display and the input are part of a touchscreen interface of the mobile computing device. In various configurations, the operating system can be an iOS operating system, an Android operating system, a Linux-based operating system, or a Microsoft Windows operation system. Each cloud storage device in the generated list of cloud storage devices can be approved against a company policy, for example to ensure each cloud storage device is on an approved list of cloud storage devices or to ensure a suitable level of encryption is used during communications with the cloud storage service. The processor also can remove from the list one or more cloud storage devices that are not associated with a cloud storage application resident on the mobile computing device. The processor also can modify the list to include a cloud storage device that is associated with a resident cloud storage application that has been installed on the mobile computing device, for example a cloud storage application that has been installed since the last time the operating system was queried. The processor also can refresh the list of cloud storage devices, for example based on a user request to refresh the list, the opening or execution of an application, the reactivation of an application, for example an application that was out of scope for a period of time and then brought back in scope, and a periodic timer. The processor also can send some of the list or all of the list to a separate application that is also executing on the mobile computing device.

A method of determining available output devices includes determining one or more cloud storage applications that are resident on a mobile computing device and, for each one, determining an associated cloud storage service that is associated with the cloud storage application and adding that associated cloud storage service as a selectable output device to a list of available output devices. The operation of determining can include querying the operation system for one or more cloud storage applications that are installed on the mobile computing device.

### BACKGROUND

Cloud storage servers allow users to store documents and files on remote systems. For example, a user on a smartphone can back up a picture or video to a remote server, thereby using the cloud storage server as backup storage for files also stored on the user's mobile computing device. Alternatively, the user may desire to move the picture or video to the remote server and thereby use the cloud storage server as additional memory space to supplement the limited memory space of their mobile computing device. In another example, a user can use a cloud storage server as the principle storage location of a particular document, allowing the user to access and edit the document from any suitable computing device such as the user's work computer, home computer, or mobile computing device. In another example, the cloud storage server can function as a temporary file space for performing operations such as printing, faxing, or emailing documents. In this example, a user may send or print a document to the cloud storage server which subsequently sends or forwards the received file to the appropriate device or party. For example, a user may print a document to a cloud storage server that is associated with one or more multifunction printers; the user can then access the document from the multifunction printer and perform an action such as printing the document. Other suitable uses of cloud storage servers are also contemplated as would be understood by one of ordinary skill in the art.

Example cloud storage services include GOOGLE DRIVE, APPLE ICLOUD, MICROSOFT ONEDRIVE, DROPBOX, ONEBOX, and TOSHIBA E-BRIDGE DOCS among other suitable cloud storage services. When a user desires use a cloud storage service, typically the user is required to manually perform an action on the user's computing device to enable access to the desired cloud storage service. For example, if a user is executing an application on a mobile computing device, the application may request the user to add or select a desired cloud storage service from a list of cloud storage services. The list of available cloud storage services can be extensive requiring the user to spend time scrolling through a long list or searching for the desired cloud storage service by name. Moreover, as new cloud storage services are expected to grow in number over time, it may become more burdensome to users to require them to search through long lists of available cloud storage services to find the desired cloud storage service.

### BRIEF DESCRIPTION OF THE DRAWINGS

FIG. 1 is a diagram of a cloud storage detection system according to an embodiment of the disclosure.

FIG. 2 is a flowchart of operations of a cloud storage detection system according to an embodiment of the disclosure.

FIG. 3 is a diagram of components of a mobile computing device configured to execute a cloud storage detection system according to an embodiment of the disclosure.

FIG. 4 is a system diagram of components of a cloud storage detection system according to an embodiment of the disclosure.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The systems and methods disclosed herein describe a cloud storage detection system for computing devices. Although the disclosed system and method are described below with regard to a mobile computing device, the system and method can be used with any suitable computing device including but not limited to mobile phones, smart phones, pad computing devices, laptops, personal computers and so forth.

The cloud storage detection system and method determines whether any cloud storage applications are installed on a computing device and generates a list of available cloud storage services based on the installed cloud storage applications. For example, if several cloud storage applications are resident on a user's mobile phone, then the cloud storage detection system and method can generate a list of cloud storage services based on the resident cloud storage applications. If a user removes a cloud storage application from the mobile phone, the cloud storage detection system can remove the associated cloud storage service from the list. If the user installs a new cloud storage application on the mobile phone, the cloud storage detection system can determine an associated cloud storage service and add that cloud storage service to the list. Cloud storage services can be restricted, based for example on company policies, to the use of secure of preapproved cloud storage service providers. Cloud storages services can be required to use specific types or strengths of encryption in communications between the cloud storage service and the computing device.

Proxy servers and middleware can be used between the computing device and cloud service provider as would be understood by one of ordinary skill in the art. In a embodiment, a multifunction printer or a system associated with one or more multifunction devices can provide the described cloud storage service.

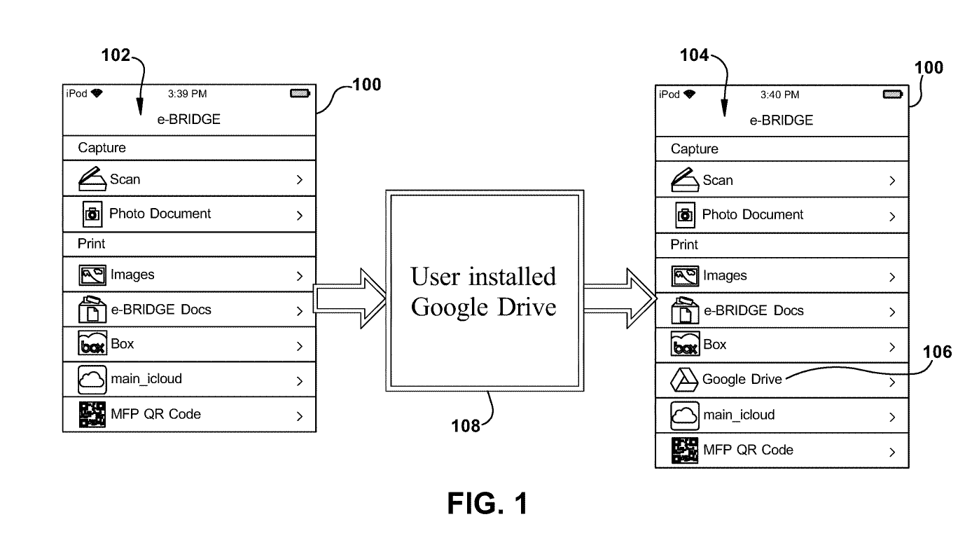

Turning to FIG. 1, a mobile computing device 100 executing an application presents a selection list 102 of available import/export services to the user. For example, a user executing an application for viewing or editing a document may desire to output the document to a cloud storage service, for example for printing or saving the document. The cloud storage detection system can dynamically determine which cloud storage applications are installed on the mobile computing device. If the cloud storage detection system determines that the user installed a new cloud storage application 108, for example GOOGLE DRIVE as shown in FIG. 1, then the cloud storage detection system determines the new cloud storage service 106 associated with the cloud storage application 108, and includes the new cloud storage service 106 in an updated selection list 104 of available import/export services.

In various embodiments, the cloud storage detection system can be incorporated into one or more applications that execute on the mobile computing platform, or the cloud storage detection system can be a system service called by one or more applications, for example by providing data for populating the import/export selection list 102 to the application or another system service, or by performing the operations of displaying the import/export selection list 102 and accepting a user selection.

In an embodiment, the cloud storage detection system generates the selection list 102 when the application begins executing on the mobile computing device 100. In an embodiment, the cloud storage detection system generates the initial selection list 102 based on previously stored data. In an embodiment, the cloud storage detection system updates the selection list 102 when the application executing on the mobile computing device 100 calls the service to display available import/export selections. In an embodiment, the cloud storage detection system updates the selection list 102 if the application executing on the mobile computing device 100 changes focus, for example by becoming temporarily an application executing in the background, and then restored to the foreground. In this embodiment, the user may have placed the application into the background in order to install a new cloud service application on the mobile computing device, such as GOOGLE DRIVE as illustrated in FIG. 1; the cloud storage detection system dynamically updates the selection list when the application returns to the foreground. In an embodiment, the cloud storage detection system can determine if a particular service should be removed, for example if an associated cloud storage application has been removed from the mobile computing device. In an embodiment, the cloud storage detection system provides updates to the application or a system service that separately handles calls to the selection menu; updates can include, for example, cloud storage services to be added to the list and cloud storage services to be removed from the list. In an embodiment, the cloud storage detection system determines which cloud storage applications are installed on the mobile computing device by sending a query to the operating system. In an embodiment, the cloud storage detection system determines which cloud storage applications are installed on the mobile computing device by examining memory of the operating system. In an embodiment, the cloud storage detection system can organize or sort the selection list 102, for example by the type of import/export service, by the frequency of use, by alphabetical order, or by any other suitable organization or sorting algorithm.

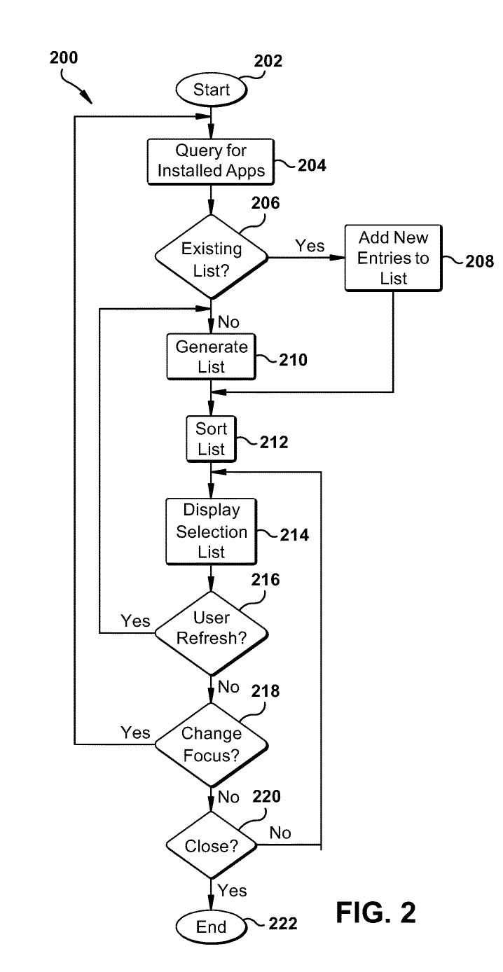

Turning now to FIG. 2, a flowchart of example operations of an automated cloud storage finder is presented. Operation commences at start block 200 labeled “START” and proceeds to process block 202.

In process block 202, an application executes in a computing device such as a mobile computing device, a pad computing device, a laptop, or a personal computing device. In various embodiments, the application is a stand-alone application, an application called by an operating system, an application called by another application, or an application opened by a user that includes code for executing instructions for finding cloud storage applications. Processing continues to process block 204.

In process block 204, the application queries for installed programs on the computing device. For example, the application can query the operation system of the computing device for programs installed on the computing device. In another example, the application can search the computing device for programs installed on the computing device that are associated with known cloud storage applications, such as GOOGLE DRIVE, APPLE ICLOUD, MICROSOFT ONEDRIVE, DROPBOX, ONEBOX, TOSHIBA E-BRIDGE DOCS, and so forth. In this example, a list of known cloud storage applications can be updated periodically or retrieved by querying a remote database. Processing continues to decision block 206.

In decision block 206, if a previous list of cloud storage devices exists, then processing continues to process block 208, otherwise processing continues to process block 210 to generate a list of cloud storage devices. For example, the previous list of cloud storage devices may have been generated by the application during a previous execution of the application, or a previous list may have been generated by the operating system of the computing device.

In process block 208, the application compares the existing list of cloud storage devices, or other output devices, and adds new cloud storage devices from processing block 204 to the list of available cloud storage devices. In a configuration, the application only adds the new cloud storage device based on company policies, for example if the new cloud storage device is on a list of preapproved cloud storage sites, or if the new cloud storage device is a secure cloud storage site that uses a form of encryption. In a configuration, the company policy can require the selection of a particular encryption type or strength of encryption for use with the cloud storage service. In a configuration, based on company policies, unapproved cloud storage devices can be removed from the list. Processing continues to process block 212.

In process block 210, the application generates a list of available cloud storage devices from process block 204. In a configuration, the list of available cloud storage devices is generated based on company policies, for example using only cloud storage devices that are on a preapproved list of cloud storage sites, or that support a particular encryption type or encryption strength. Processing continues to process block 212.

In process block 212, the list is sorted in accordance to user preferences for presentation to the user at process block 214. For example, the list can be sorted alphabetically or by frequency of use by the user of the computing device. In this way, the user behavior is tracked on the computing device and the most frequently used cloud storage devices are presented at the top of the list to the user. In a configuration, the sort can be based on company policy, for example to promote a specific cloud storage service to users. Processing continues to process block 214.

In process block 214, the list of available cloud storage devices is presented. For example, the list can be presented to the user of the computing device, for example as an available option for outputting a file or document. The list may be presented as part of a larger list of output options. For example, when the user is operating their computing device, the user may desire to output the current file, document, or screen to an output device, such as a printer. In addition to a list of printers, the available cloud storage devices can be presented as output options. In an embodiment, the list of available cloud storage devices is presented to another application or service, instead of directly to the user. Processing continues to decision block 216.

In decision block 216, if the user desires to refresh the list of available cloud storage devices, then processing returns to process block 210 to generate a list of available cloud storage devices. For example, the current list of available output devices may include cloud storage devices services that were previously installed on the computing device but which have been subsequently removed by the user. Refreshing the list of available cloud storage devices allows the user to regenerate the list of available cloud storage devices based on the query in process block 204. Processing continues to decision block 218.

In decision block 218, if the application is reactivated, then the application can optionally return to process block 204 to query for installed cloud storage applications. For example, a user on a computing device, such as a mobile computing device, can temporarily change focus to another application, and then return to focus back to the original application. This can flag the application to check if any new cloud storage applications were installed to the computing device. For example, a user may desire to use GOOGLE DRIVE on their mobile computing device, but find that GOOGLE DRIVE is not listed as an installed cloud storage device. The user can use the home button on their mobile computing device to return to the main selection screen, select an application that directs the user to a store or download site for installing the GOOGLE DRIVE application to their mobile device, and then return to the original application. The original application can determine that focus has returned to the application, and upon reactivation processing is returned to process block 204 to query for newly installed cloud storage applications. If the application is not reactivated, then processing continues to decision block 220.

In decision block 220, if the application is closed or otherwise terminated, then processing continues to end block 222 labeled “END” and processing terminates, otherwise processing returns to process block 214 to display available cloud storage applications.

Generally, the processes described above can be performed in any suitable order, and omit or combine steps or actions as would be understood by one of ordinary skill in the art. For example, the application can query for a list of existing cloud storage devices on the user's mobile computing device at any time, including but not limited to when the application is launched, closed and opened, reactivated, periodically, or when the view is refreshed.

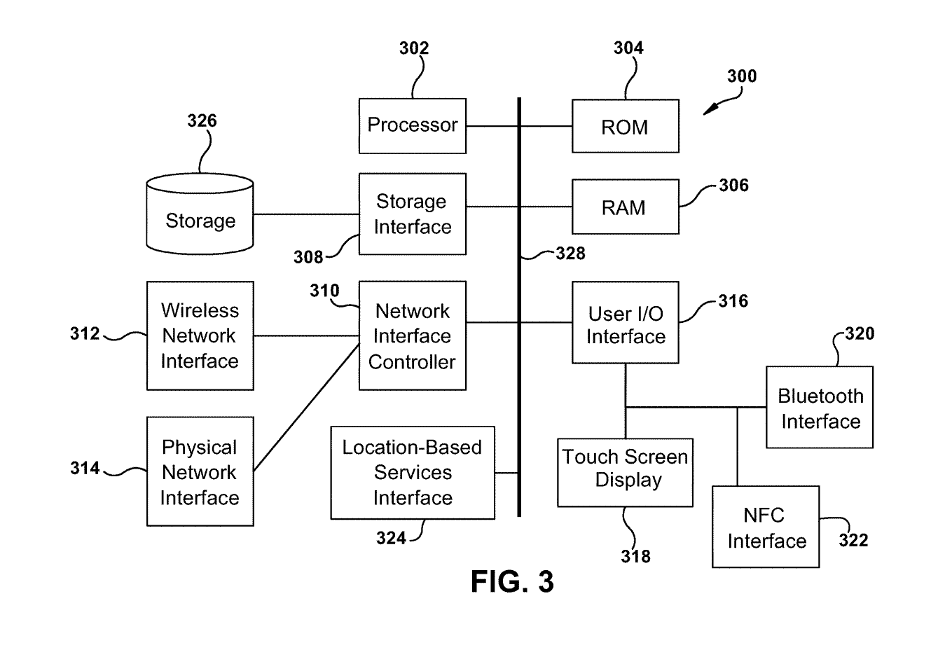

Turning now to FIG. 3, presented are functional components 300 of a computing device configured to execute the automated cloud storage finder application. Included in the computing device are one or more processors, such as are illustrated by central processor unit (CPU) 302. Also included are non-volatile memories configured to store instructions and data, such as read-only memory (ROM) 304, random access memory (RAM) 306, a storage interface 308, a network interface 310, and I/O interface 316. In the example embodiment, CPU 302, ROM 304, RAM 306, storage interface 308, network interface 310, and I/O interface 316 are in mutual data communication via bus 328. Storage interface 308 facilitates data access with bulk data storage, such as one or more disks 326, or any other suitable data storage such as a flash drive, solid state storage drive, CD, DVD or the like.

Network interface 310 suitably provides for external data communication, such as with a network interface connection (NIC) 314 or WiFi interface 312. NIC 314 or WiFi interface 312 suitably provide for connection to an associated local area network. The input/output controller or I/O interface 316 suitably provides support for a BLUETOOTH interface 320, a near field communication interface 322, and the user interface. The user interface can include a display screen and touchscreen inputs, which together can form a touch screen display 318, key inputs such as keypad or keyboard inputs, audible outputs such as a speaker, and so forth. I/O interface 316 can support standardized inputs and outputs, such as VGA, HDMI, USB, and serial interfaces, or can be configured to support proprietary cabling and/or proprietary interfaces.

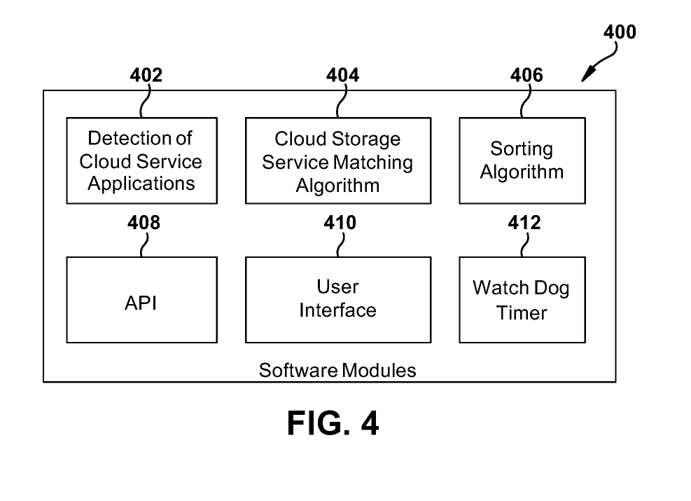

Referring now also to FIG. 4, presented are example software modules of a computing device for executing a cloud storage detection application. A detection module 402 detects which cloud storage applications are resident on the mobile computing device, for example by querying the operating system or examining memory of the mobile computing device. A matching module 404 determines receives the data about which cloud storage applications are resident on the mobile computing device and determines the associated cloud storage services to add to the selection list. A sort module 406 organizes and sorts the services that are displayed on the selection list. The services can be sorted by type, for example where the available services are for inputting or outputting files and documents, by alphabetical order, by frequency of use, and so forth. An API module 408, or application programming interface module, facilitates communicating data with other applications, programs, or system services. For example, in an embodiment the cloud storage detection system determines the list of available cloud storage services and passes that information to another application for display by that application. A UI module 410, or user interface module, presents the selection list to the user and accepts user selection of a desired service to use for input or output of a file or document, for example a user selection of a particular cloud storage service to which a document is sent. A watchdog module 412 determines whether the selection list is to be updated. For example, when the cloud storage detection system determines that an associated application begin executing, the watchdog module 412 can load a previously saved selection list of input and output services, and trigger the detection module 402 query the operating system for resident cloud storage applications. If the focus of the application is changed to background mode and then restored to the foreground, the watchdog module 412 can trigger the detection module 402 to check for changes in installed cloud storage applications. The watchdog module 412 can also periodically trigger the detection module 402 to detect changes. If the application is terminated, the watchdog module 412 can save the current selection list that is reloaded the next time that the application executes.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A method, comprising:
retrieving, on a mobile computing device, identifying data about cloud storage applications resident on the mobile computing device;
generating a list of cloud storage devices based at least in part on the identifying data;
presenting, on the mobile computing device, at least a portion of the list;
accepting, on the mobile computing device, a selection of a cloud storage device from the list as a selected cloud storage device; and
outputting data from the mobile computing device to the selected cloud storage device.

2. The method of claim 1, wherein retrieving identifying data includes querying an operating system of the mobile computing device for the identifying data.

3. The method of claim 1, wherein each cloud storage device in the generated list of cloud storage devices is approved against a company policy.

4. The method of claim 1, further comprising:
removing from the list a cloud storage device that is not associated with a resident cloud storage application.

5. The method of claim 1, further comprising:
modifying the list to include a cloud storage device associated with a resident cloud storage application that has been installed on the mobile computing device.

6. The method of claim 1, further comprising:
refreshing the list of cloud storage devices based upon one or more of a user request to refresh the list, an opening of an application, a reactivation of an application, and a periodic timer.

7. The method of claim 1, wherein presenting includes displaying, on a display associated with the mobile computing device, at least a portion of the list.

8. The method of claim 1, wherein presenting includes passing at least a portion of the list to a separate application executing on the mobile computing device.

9. The method of claim 1, wherein accepting a selection of a cloud storage device includes accepting, via an input associated with the mobile computing device, a user selection of a selected cloud storage device.

10. The method of claim 1, wherein outputting data includes transmitting, via a wireless network interface associated with the mobile computing device, the data to the selected cloud storage device.

11. A mobile computing device, comprising:
a memory operable for storage of data and instructions;
a network interface configured for mobile communications;
a display configured to visually present data to a user;
an input configured to accept user inputs from the user; and
a processor in data communication with the memory, the network interface, the display, and the input, the processor configured to
retrieve, from the memory, identifying data about one or more cloud storage applications resident on the mobile computing device;
generate a list of cloud storage devices based at least in part on the identifying data;
present, on the display, at least a portion of the list;
accept, via the input, a user selection of a cloud storage device from the list as a selected cloud storage device; and
output data, via the network interface, to the selected cloud storage device.

12. The mobile computing device of claim 11, wherein the display and the input comprise a touchscreen interface.

13. The mobile computing device of claim 11, wherein the processor is further configured to query an operating system of the mobile computing device for the identifying data.

14. The mobile computing device of claim 11, wherein each cloud storage device in the generated list of cloud storage devices is approved against a company policy.

15. The mobile computing device of claim 11, wherein the processor is further configured to
remove, from the list, a cloud storage device that is not associated with a resident cloud storage application.

16. The mobile computing device of claim 11, wherein the processor is further configured to
modify the list to include a cloud storage device associated with a resident cloud storage application that has been installed on the mobile computing device.

17. The mobile computing device of claim 11, wherein the processor is further configured to
refresh the list of cloud storage devices based upon one or more of a user request to refresh the list, an opening of an application, a reactivation of an application, and a periodic timer.

18. The mobile computing device of claim 11, wherein the processor is further configured to
send at least a portion of the list of cloud storage devices to a separate application executing on the mobile computing device.

19. A method of determining available output devices, comprising:
determining one or more cloud storage applications resident on a mobile computing device; and
for each cloud storage application resident on the mobile computing device,
determining an associated cloud storage service associated with each cloud storage application, and
adding the associated cloud storage service as a selectable output device to a list of available output devices.

20. The method of claim 19, wherein the operation of determining further comprises querying the operating system of the mobile computing device for one or more cloud storage applications installed on the mobile computing device.
